(19) United States
(12) Patent Application Publication
(10) Pub. No.: US 2025/0156901 A1
(43) Pub. Date: May 15, 2025

(54) System and method for compensation of individual data providers

(71) Applicant: David G Beck, Los Angeles, CA (US)

(72) Inventor: David G Beck, Los Angeles, CA (US)

(21) Appl. No.: 17/308,002

(22) Filed: May 4, 2021

(51) Int. Cl. G06Q 30/0241; G06Q 30/0251; H04W 4/021

(52) U.S. Cl. CPC G06Q 30/0247; G06Q 30/0261

(57) ABSTRACT

The system allows for profit generated through data-based targeting of digital advertisements to be redistributed to the individual creators/owners of the personal data used to facilitate the targeting process. The system creates, via a mobile application, an opt-in data pool of “zero-person” data (obtained via an enrolment questionnaire and/or behavioural tracking methods.) Once collective data has been sold for use in targeting, the app will use the same digital pathways employed for member identification/contribution to remunerate contributors with a proportional share of the generated revenue, regardless of each member's actual interaction with said advertising. The system provides a dedicated channel for advertisements to reach targeted contributors. The system further provides a method for calculation and graphical display of the contributor's share value, as well as a means of transferring funds to a member's personal financial account.

### FIELD OF THE INVENTION

The invention relates generally to the field of mobile advertising and more specifically to the field of compensating the providers of personal data used for targeting mobile digital advertisements.

### BACKGROUND OF THE INVENTION

Targeted advertising techniques have undeniably enhanced the effectiveness and efficiency of marketing communications in the digital era; a fact witnessed by the AdTech industry's explosive growth in recent years. With what is essentially a digital billboard in the pocket of nearly every consumer, modern advertising has been democratized and personalized in a way unimaginable in the age of mass media. This impressive growth has been fuelled by unprecedented access to massive reservoirs of digitized personal information. But if personal data is to be considered the “new oil” of the 21st century, current methods of extracting that data can be compared to “fracking”—a technique that is crude, expensive, and not without significant negative impact. The process is ripe for improvement.

As an individual's online behaviour is increasingly tracked and recorded for marketing purposes, “surveillance capitalism” has alienated the consumer it intends to entice. Already hostile to an advertising industry which has historically appropriated and commodified her attention with little to no personal reward, the consumer in the digital age now reacts with a reflexive desire to protect her digital identity from even further exploitation. This defensive posture forces AdTech companies to adopt increasingly surreptitious means in their pursuit of the data driving the industry, negatively reinforcing the consumer's initial antipathy toward them.

At macro scale, AdTech's relentless pursuit of personal information has spawned a variety of nation and state-level regulatory regimes set on protecting consumer privacy and attempting to control the lopsided appropriation of this valuable new resource. As a result, data acquisition has become an increasingly expensive game of cat and mouse. Globally, businesses are forced to adopt explicit opt-in measures and provide clear privacy policies to consumers, undercutting their ability to appropriate data undetected. To counter these new hurdles, marketers turn to increasingly surreptitious “dark patterns” for obtaining personal data.

The furtive nature of Ad Tech's current approach to data acquisition inherently debases the quality of the information obtained. Like shale oil, the raw product requires significant amounts of processing to become useful. Algorithms attempt to sift away impurities and add value, but their complexity adds significant expense to a final output which amounts, at best, to predictive conjecture.

To further minimize the guesswork of effective ad placement, marketers must navigate multiple layers of intermediaries which add even more cost to the process. Despite these attempts to improve the quality of appropriated data, ad irrelevancy and consumer resistance in the form of “ad blindness” continue to plague the digital advertising landscape, compounding the system's inefficiency.

The misguided approach to modern digital ad delivery is based on the industry's historic perception of the audience as oppositional to the advertising process. In the age of mass media, marketers had little real-time knowledge of where their customers were and even less knowledge of who actually received their messaging. Advertisers were forced to thrust themselves in front of the largest audiences possible in the hope of connecting with a fractional number of leads. The crude delivery and intrusive nature of this approach crated antagonism between marketer and consumer. Despite the seismic shift in the methods of modern ad delivery, players in the AdTech arena have not evolved in their view of the audience as oppositional. As they run circles searching for new avenues to extract data from unwitting subjects and new channels on which they can appropriate attention, none have stopped to consider the power of simply asking the audience to become a willing participant in the process.

Today, we need to consider that the digital methods which currently give marketing professionals the ability to identify highly specific segments for targeting also open a pathway for directly rewarding the individuals in those segments for their receptivity. The establishment of a truly bilateral system—one in which the viewer is fairly rewarded for their contributions to the advertising process (data-sharing and ad viewing)—would resolve many of the frictions that exist under the current digital ad delivery regime.

In such a system, the consumer becomes a stakeholder in the advertising process and is motivated not only to willingly accept digital messaging but also to openly share the resource essential for its effective targeting. Because the consumer has willingly opted in to the audience pool, privacy issues surrounding the data collection process are obviated. Consumers' feelings of exploitation and resentment to AdTech wither. Advertisements are now welcomed as a source of both personally relevant information and financial reward to their viewers. Armed with data of unassailable quality, the marketer can confidently target precise segments of receptive audiences with unprecedented accuracy and efficiency.

In order for an individual's data to have value to the marketer, it must be combined with that of a massive population from which usable audiences can be drawn. The concept of forming pools of directly compensated data providers has gained currency in recent months. Mediators of Individual Data (organisations which attempt to bring data providers together in collective pools) exist in various forms but typically reward the individual data provider with either a fixed access fee or some form of points/credits as remuneration. Some MIDs will only compensate users for actual engagement with advertising. Because these compensatory structures are so disproportional to the value of the resource being ceded, it's unsurprising that MIDs have proven disappointing in their ability to gain a foothold; in actuality they do little to diminish the data's provider's existing sense of exploitation. A second hindrance posed by many MIDs is their requirement for members to actively manage and oversee the use of their data. While these standards most likely exist to create sense of control for the member, active management can be a cumbersome process. Meanwhile, as the consumer's data continues to be siphoned by outside parties, the sense that “control” is illusory makes the attempt to establish it seem futile.

A better way to convert the consumer into a willing and motivated stakeholder in the digital advertising process is by: 1) providing a simple path of entry to the collective pool, requiring no subsequent management on the part of the provider, and 2) distributing a truly proportional share of the revenue generated from the collective data pool back to each contributing member.

The present invention addresses a method to achieve this goal.

### SUMMARY OF THE INVENTION

The present invention relates to a system and method for compensating suppliers of personal data used for targeted-advertisement delivery. In particular, the invention relates to an application on a mobile device which would achieve three main goals:
1. The establishment of a pool of data providers. Said providers will enroll as members by providing detailed personal information through a sign-up survey form presented by the app. Follow-up surveys will be periodically sent to keep member information updated. Providers will allow access to their mobile device's location data, other installed apps, and as much behavioral data as they are comfortable with and that the device manufacturer will allow. Further personal data may be shared by linking third-party accounts, such as customer loyalty and frequent flyer programs, or credit card and banking information—all at the member's discretion.
2. A method for delivering advertisements to the member's device based on the personal/location/behavioral data provided. Advertisements may be delivered in-app to a specific UI element (FIG. 1.1e) when the application is opened, via location triggered SMS alerts, or through third party apps, websites or any other marketing real estate which contracts for access to the data provider pool.
3. A method for calculating, displaying and delivering a member's share of the total revenue generated by the data pool during the time they have had an active membership and the app installed on their device. When opened, the app interface will display the current value of the member's account (FIG. 1.1a) and give an option for transferring those funds to a personal account (FIG. 1.1d).

Other functions of the present embodiment described herein include but are not limited to:
a.) A method for providing a means to initiate a user defined search query (FIG. 1.1c),
b.) A method for providing a means to access a dedicated channel of advertisements (FIG. 1.1b) which are curated and categorized based on data provided.

### BRIEF DESCRIPTION OF DRAWINGS

Some embodiments of the present invention are illustrated as an example and are not limited by the figures of the present drawings, in which:

FIG. 1 shows elements of the user interface for the consumer-facing mobile application according to various embodiments described herein.

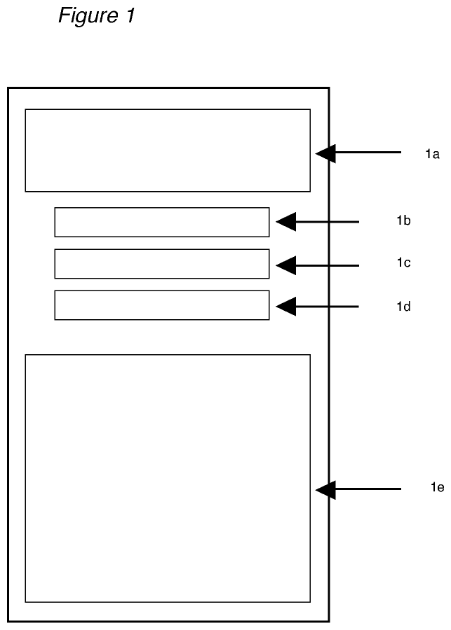

FIG. 2 shows an example of the functional flow for various actions facilitated by the mobile application according to various embodiments described herein, specifically: user registration, revenue redistribution, and member payout.

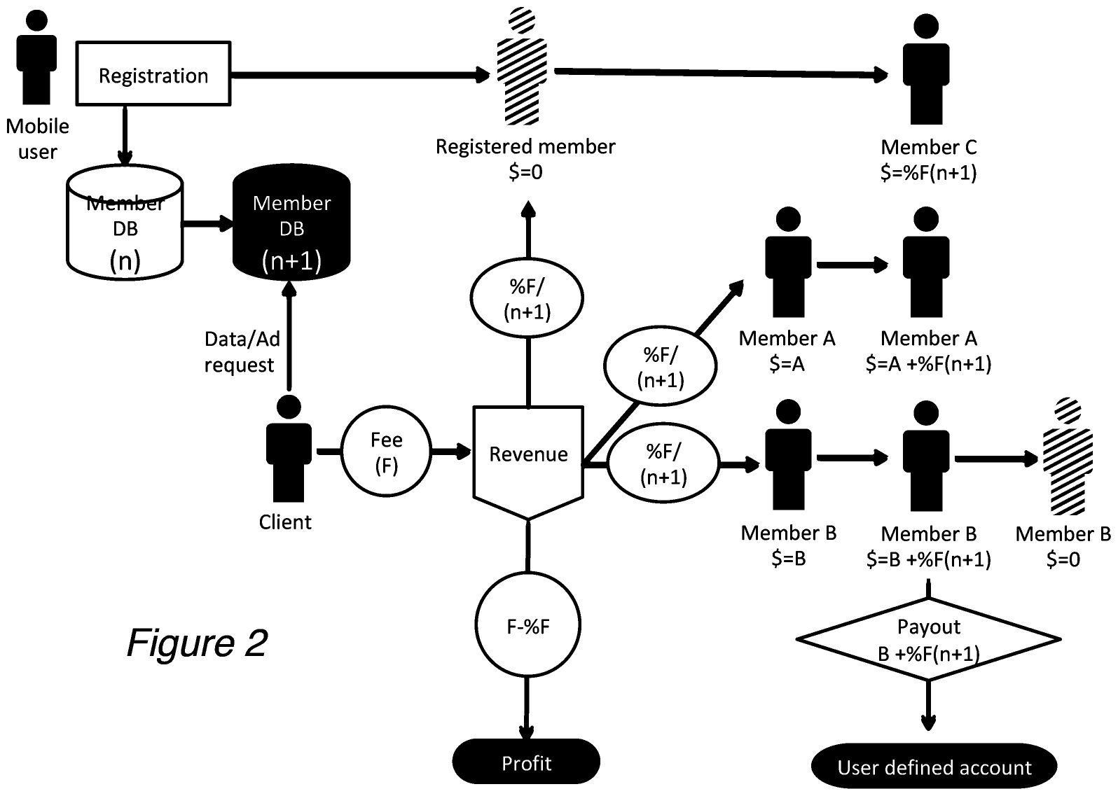

1. A method for establishing a pool of members/data providers whose data is to be used for targeted advertising; and for calculation and redistribution of advertising revenue derived from the collection of said member data embodied in a mobile app comprising but not limited to: a user interface for a.) facilitating entry of member registration details b.) displaying the total revenue earned by the user (1) c.) displaying advertisements (5) d.) providing a means to initiate revenue transfer to a user-defined account (4), providing a means to initiate a user defined search query (3), providing a means to access a dedicated channel of advertisements deemed relevant to the user based on data provided (2), location tracking services to collect locational data, background services designed for retrieval and delivery of advertisements to members' devices based on stored profile and active locational data, background services to calculate revenue totals intended for redistribution to app users.

2. A system according to claim 1 which provides a method for storing member/provider data amassed via a mobile app for the purpose of generating revenue which is to be calculated for redistribution to app users by a pre-determined metric.

3. A system according to claim 1 wherein a percentage of the revenue generated by the data pool is calculated for redistribution to members/data providers via a mobile app comprising: background services for revenue calculation, a mobile app user interface element to display members' real time share value (1), a UI element (4) allowing the user to initiate a transfer of said revenue to a user-defined account.

4. A system according to claim 1 whereby a member's calculated percentage of the revenue generated by the data pool is distributed back to the member via a mobile app comprising: a UI element to initiate the transfer, background services to facilitate the transfer to a user defined account.

5. A system according to claim 1 whereby audience segments are targeted for in-app ad delivery to a specific viewing area in the user interface (5) based on:
personal data provided to/amassed by the app, and/or geolocation techniques, and/or geofencing techniques used by the app, for the purpose of generating revenue which is to be calculated for redistribution to app users via the app by a pre-determined metric.

6. A system according to claim 1 whereby access is provided to a channel of advertisements deemed relevant based on: personal data provided to/amassed by the app, and/or geolocation techniques, and/or geofencing techniques used by the app, for the purpose of generating revenue which is to be calculated for redistribution to app users via the app by a pre-determined metric comprising: a UI element to initiate the channel stream, a UI page on the app to display and manage said advertisements.

7. A system according to claim 1 whereby alerts and advertisements are delivered via SMS/MMS to the mobile devices of targeted data providers based on personal data provided to/amassed by the app, and/or geolocation techniques, and/or geo-fencing techniques used by the app, for the purpose of generating revenue which is to be redistributed to app users via the app by a pre-determined metric.

8. A system according to claim 1 whereby market segments are determined and targeted for third-party in-app ad delivery by the app through analysis of personal data provided to/amassed by the app, and/or geolocation techniques, and/or geo-fencing techniques used by the app, for the purpose of generating revenue which is to be redistributed to app users via the app by a pre-determined metric.

9. A system according to claim 1 whereby market segments are determined and targeted for ad delivery to digital outdoor media (billboards, ect) by the app through analysis of personal data provided to/amassed by the app, and/or geolocation techniques, and/or geo-fencing techniques used by the app, for the purpose of generating revenue which is to be redistributed to app users via the app by a pre-determined metric.

10. A system according to claim 1 whereby personal data provided to/amassed by the app, and/or obtained through geolocation techniques, and/or obtained through geo-fencing techniques used by the app, is sold as raw third party data for the purpose of generating revenue which is to be redistributed to app users via the app by a pre-determined metric.

11. A system according to claim 1 which provides a method for members/data providers to make a specific query (3) resulting in the delivery of relevant advertisements, for the purpose of generating revenue which is to be redistributed to app users via the app by a pre-determined metric

12. A method for allowing third parties access to the established pool of member data which has been amassed for the purpose of generating revenue which is to be calculated for redistribution to app users by a pre-determined metric, embodied in a companion enterprise mobile app comprising but not limited to a “dashboard” interface for the input of attributes defining the desired audience.
